(19) United States
(12) Patent Application Publication
(10) Pub. No.: US 2009/0101223 A1
(43) Pub. Date: Apr. 23, 2009

(54) REGULATOR FOR CLUTCH

(76) Inventor: Deok Ki Kim, Hwaseong-city (KR)

Correspondence Address: MORGAN, LEWIS & BOCKIUS LLP (SF), One Market, Spear Street Tower, Suite 2800, San Francisco, CA, 94105, US

(21) Appl. No.: 11/952,323

(22) Filed: Dec. 7, 2007

(30) Foreign Application Priority Data
Oct. 19, 2007 (KR) 10-2007-0105511

(51) Int. Cl. F16L 55/04; F16D 13/60

(52) U.S. Cl. 138/30; 192/107 R; 138/42; 138/43

(57) ABSTRACT

A regulator for a clutch includes a regulator housing, first and second plates in the regulator housing, and a support plate attached to the regulator housing. The first plate may be convex in a direction opposite the second plate. The first plate may include at least one oil passage hole. The first plate may be thinner than the second plate. A first damping member may be provided between the regulator housing and the first plate, and a second damping member may be provided between the second plate and the support plate.

### CROSS-REFERENCE TO RELATED APPLICATION

This application claims priority to, and the benefit of Korean Patent Application No. 10-2007-0105511, filed in the Korean Intellectual Property Office on Oct. 19, 2007, the entire contents of which are incorporated herein by reference.

### BACKGROUND OF THE INVENTION

(a) Field of the Invention

The present invention relates to a regulator for a clutch with a double plate.

(b) Description of the Related Art

Referring to FIG. 1, a typical clutch activating mechanism 10 for a manual shift vehicle includes a clutch pedal 3, a hydraulic pressure line 5, and a regulator 7 disposed in the hydraulic pressure line 5.

The regulator 7 reduces noise and vibration induced by pulsation generated by operation of the clutch pedal and by vibrations of the engine or transmission.

A typical gasoline vehicle mainly generates low frequency pulsation and thus a thin damping plate (of about 0.8 mm thickness) is provided in the regulator 7 for reducing the low frequency pulsation. It is therefore ineffective at damping high frequency pulsation.

A typical diesel vehicle mainly generates high frequency pulsation and thus uses a thick damping plate (of about 1.2 mm thickness). It is therefore ineffective at damping low frequency pulsation.

The above information disclosed in this Background section is only for enhancement of understanding of the background of the invention and therefore it may contain information that does not form the prior art that is already known in this country to a person of ordinary skill in the art.

### SUMMARY OF THE INVENTION

A regulator for a clutch includes a regulator housing, first and second plates in the regulator housing, and a support plate attached to the regulator housing. The first plate may be convex in a direction opposite the second plate. The first plate may include at least one oil passage hole. The first plate may be thinner than the second plate. A first damping member may be provided between the regulator housing and the first plate, and a second damping member may be provided between the second plate and the support plate.

### BRIEF DESCRIPTION OF THE DRAWINGS

FIG. 1 is a schematic view showing a clutch actuating mechanism.

FIG. 2 is a cross-sectional view showing a regulator for a clutch actuating mechanism according to an exemplary embodiment of the present invention.

FIG. 3 is a perspective view showing a first plate for reducing vibration according to an exemplary embodiment of the present invention.

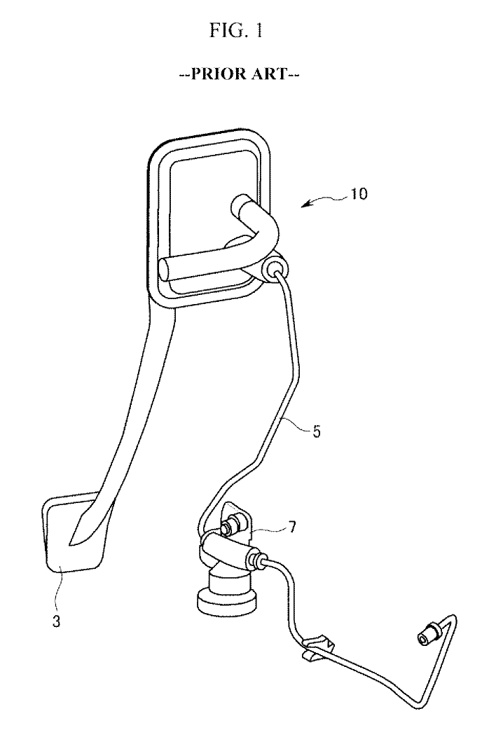

### DETAILED DESCRIPTION OF PREFERRED EMBODIMENTS

An exemplary embodiment the present invention will be described more fully hereinafter with reference to the accompanying drawings.

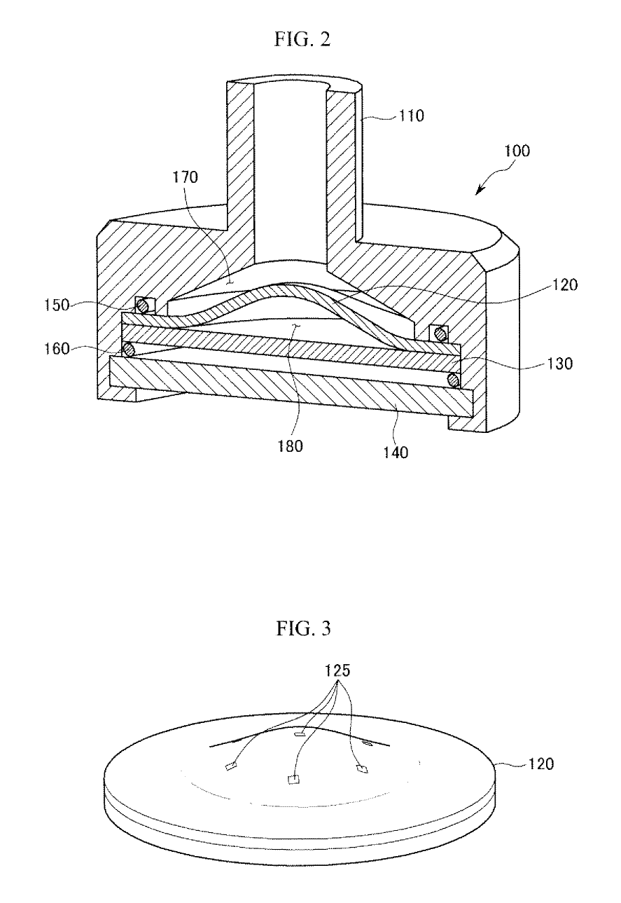

Referring to FIG. 2 and FIG. 3, a regulator 100 for a clutch activating mechanism according to an exemplary embodiment of the present invention includes a regulator housing 110, a first plate 120 disposed in the regulator housing 110, a second plate 130 disposed below the first plate 120 in the regulator housing 110, and a support plate 140 attached to the regulator housing 110.

The first plate 120 is convex in the upward direction.

A first chamber 170 is provided between the regulator housing 110 and the first plate 120, and a second chamber 180 is provided between the first plate 120 and the second plate 130.

At least one hole 125 is provided on the first plate 120 for oil to pass through. The size and number of holes 125 can be selected by a person of ordinary skill in the art according to the size of an engine, vibration characteristics, and so on, based on the teachings herein.

The first plate 120 is thinner than the second plate 130. The first plate 120 is for reducing low frequency pulsation and the second plate 130 is for reducing high frequency pulsation. Exemplary thicknesses are 0.8 mm and 1.2 mm, respectively.

A first ring 150 is disposed between the regulator housing 110 and the first plate 120 for reducing vibration. A second ring 160 is disposed between the second plate 130 and the support plate 140 for reducing vibration. The rings 150, 160 may be made of an elastic material, such as a rubber.

Hereinafter, operation of the regulator will be explained.

There is clutch fluid in the chambers 170, 180. Pulsation generated in the engine (not shown) or transmission (not shown) is transmitted through the clutch oil.

If the vibration is of a relatively low frequency, the first plate 120 flexes up and down and absorbs the low frequency vibrations of the clutch fluid, while the second plate 130 is fixed and provides support.

If the vibration is of a relatively high frequency, the first plate 120 and the second plate 130 both flex up and down and absorb the high frequency vibrations of the clutch fluid, while the support plate 140 provides support.

The rings 150, 160 also absorb vibrations.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A regulator for a clutch, comprising:
a regulator housing;
a first plate disposed in the regulator housing;
a second plate disposed in the regulator housing; and
a support plate attached to the regulator housing.

2. The regulator of claim 1, wherein the first plate is convex in a direction substantially opposite the second plate.

3. The regulator of claim 1, wherein the first plate comprises at least one oil passage hole.

4. The regulator of claim 1, wherein the first plate is thinner than the second plate.

5. The regulator of claim 1, further comprising a damping member between the regulator housing and the first plate.

6. The regulator of claim 1, further comprising a damping member between the second plate and the support plate.

7. The regulator of claim 1, further comprising a first damping member between the regulator housing and the first plate and a second damping member between the second plate and the support plate.
